(19) United States
(12) Patent Application Publication
(10) Pub. No.: US 2026/0148226 A1
(43) Pub. Date: May 28, 2026

(54) SYSTEMS, METHODS, AND MEDIA FOR CAPTURING TRANSACTION INFORMATION THROUGH A PAYMENT NETWORK

(71) Applicant: Ayrton J. Day, Henderson, NV (US)

(72) Inventor: Ayrton J. Day, Henderson, NV (US)

(21) Appl. No.: 18/959,305

(22) Filed: Nov. 25, 2024

Related U.S. Application Data
(60) Provisional application No. 63/543,837, filed on Oct. 12, 2023.

(51) Int. Cl. G06Q 20/38; G06Q 20/04; G06Q 20/40

(52) U.S. Cl. CPC G06Q 20/3827; G06Q 20/047; G06Q 20/3829; G06Q 20/389; G06Q 20/401

(57) ABSTRACT

A system and methods to capture, store, track, and sort through receipt information details following a merchant/purchaser transaction executed through an electronic payment system. The system provides storage and analytical capabilities to provide access to and the utilization of the captured data by the merchant user, the purchaser user, and permitted third parties. The system operates by a secure hashing algorithm receiving a plurality of transaction information from a point of sale system. The secure hashing algorithm generates a primary key using the plurality of transaction information. A database receives and stores the primary key. The primary key is used when sending the plurality of transaction information to the database to encrypt the plurality of transaction information.

### CROSS-REFERENCE TO RELATED APPLICATIONS

The present application claims priority to U.S. Provisional Application No. 63/543,837 filed Oct. 12, 2023, titled “SYSTEMS, METHODS, AND MEDIA FOR CAPTURING TRANSACTION INFORMATION,” which is hereby incorporated by reference in its entirety.

### TECHNICAL FIELD

The embodiments disclosed herein generally relate to systems and methods for electronically gathering, storing, sorting, and accessing transaction-relevant information in commerce.

### BACKGROUND

Traditionally when a purchase is made at a physical location or online, a Purchaser selects multiple items or services of varying quantities and price, then chooses a method of payment. Once the transaction is approved a receipt is printed detailing the transaction data. Currently purchasers of goods and services that execute transactions using one or more payment instruments are not able to access consolidated receipt information other than by paper receipt, email, or other non-consolidated report.

Physical receipt copies (hard copies) are cumbersome as most bookkeeping and accounting is done electronically forcing users to manually keep track of and enter data into these systems. This method is also prone to errors such as miss prints making data hard to read or verify as well as misplacement, loss, or damage to the hard copy. These errors can lead to complications further down the line, such as missed tax breaks or auditing issues, incomplete accounting, errors in budgeting, inability to make returns, inability to prove ownership, and many more. In addition to the many complications of hard copy receipts, unless a copy is held in person, the user does not have instant organized access to this information or the transaction data of other transactions.

Thus, there is a need for a seamless solution that electronically captures, tracks, stores, consolidates and sorts through receipt information details when merchant/purchaser transactions are made through any electronic payment method. The various reasons for post-sale access include purchase verification, returns, financial tracking, taxonomy, price tracking, bookkeeping, accounting, etc. Furthermore, a system that provides data to purchaser users selected third parties; helping improve the experience on other applications i.e., no longer having to manually input or scan receipts into accounting software. Therefore, a system is needed that allows purchaser users to access, sort, download, query, parse through details on all levels of their receipts from any location with internet access.

Currently merchants are stuck offering paper or e-mailed receipts as there is no integrated solution for effectively delivering consolidated transaction data to a purchaser. This leads to the unnecessary cost of paper and printer maintenance. Also, many Merchants are required to store copies of receipts for a mandatory number of years, this is often done by keeping physical copies in boxes or filing cabinets. Physical storage of this information is costly, inefficient, and prone to damage or loss. Furthermore, with a growing concern around waste management, security and environment, paper receipts lead to more waste and a larger carbon footprint for merchants and their supply chains, as well as potential security risks during storage and disposal.

Thus, there is a need for a solution that electronically captures stores and consolidates receipt information details during merchant/purchaser transactions. Such a solution would virtually remove the cost of paper, paper storage, shipping, and paper waste from every transaction. While also providing a safer and more accessible method of storing transaction data.

Currently Merchants have sub-optimally tried to solve the problems described above on their own. A solution has been to add a prompt at some point during the POS process to ask the purchaser for a form of contact such as a phone number or email address then a copy of the receipt is sent via the chosen contact method(s). This method adds unnecessary complexity to the check-out process as each transaction requires personal lengthy information to be entered through POS systems not typically optimized for this. Because the receipt is sent through ways designed for a plurality of notifications and information i.e., SMS (text massage) and/or email. It is easy to lose track of this information and difficult to find among the many other notifications occupying the medium.

Thus, there is a need for consolidated repository and a system that doesn't disrupt the POS process. That is, a streamlined non disruptive solution that automatically handles the capture, storage and consolidation of transaction data while requiring no additional input from the purchaser.

Yet another problem is, a lack of market insight. For Merchants, this means what competing products or services are best preforming. For Purchasers, this means, who is selling the products or services they are looking for at the lowest price or how have prices changed over time. Currently it is very difficult and tedious to realize answers to these questions.

Thus, there is a need for a consolidated solution that can provide merchant users with details of competing items or services that are being traded, down to the micro level. For example, price, date, time, location, quantity, competing merchant etc. This level of detail can provide merchant users with the market insight necessary to highly optimize the products and services they provide. Purchaser users would also benefit from being able to track the price of items over time as they go in or out of season as well as identifying the best source of value for the items or services they are seeking to purchase.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a system and methods to capture, store, track, and sort through receipt information details following a merchant/purchaser transaction executed through an electronic payment system. The system provides storage and analytical capabilities to provide access to and the utilization of the captured data by the merchant user, the purchaser user, and permitted third parties. The system operates by a secure hashing algorithm receiving a plurality of transaction information from a point of sale system. The secure hashing algorithm generates a primary key using the plurality of transaction information. A database receives and stores the primary key. The primary key is used when sending the plurality of transaction information to the database to encrypt the plurality of transaction information.

In order to link POS generated receipt data to a specific individual and or payment instrument, a key is required that can accurately identify the purchaser's method of payment, link the receipt data to it, and transfer the receipt data and key to a database/cloud server where it can be stored and further processed. Ideally this should be done without adding complexity to the POS process and without saving or disclosing personal information such as a phone number, email address, payment instrument information, etc.

In the methods described in the prior art, the key is required to be physically input by the purchaser and may in some cases require personal information to be saved or disclosed as the actual key. These methods have certain unique limitations and POS complexities as discussed in the background and related art. The most significant of which is the inability to support every payment instrument and transaction type.

There is provided herein a system and a methods for generating a primary key on demand by any part of the payer's unique payment information. The following method is referred to as method one. In the case of a credit or debit card, payment details such as the card number, card holders name, CVV, expiration date, associated card network, or a combination of, will be used to generate the primary key, using a secure hashing algorithm (SHA) a one-way hash function. These SHA's can take an input and generate a unique output (hash or digest) that is nearly impossible to reverse engineer. Any party involved in a transaction that has unencrypted access to the payment information would be able to generate the hash. The hash can then be used as the primary key when sending transaction information to a database and/or server. The SHA can be of any kind, including quantum cryptographic algorithms and can evolve with the current and future needs of data security. The system and method allow for online, in-person, and remote transactions to participate in the seamless automation of storing and accessing POS generated receipts. With the SHA method no additional hardware is needed as any point of the payment processing system/POS with basic computing power can generate the primary key and send it back to the POS system or other intermediary as described in the drawings. The method also provides flexibility to incorporate new future payment processing structures since the system is not dependent on any specific party in the payment processing chain. The method further provides flexibility for different payment instruments such as checks, crypto currency's, electronic wallets, NFC, as well as other electronic methods of payment, since the system only requires the unique payment information to generate a hash.

In another embodiment described as method two, the primary key would be generated through any method for example a random number or concatenation of unique numbers (e.g., information such as payment method, country, currency, issuing bank/institution, etc.) This primary key is then saved within the payment instrument it describes and/or some part of the payment processing system i.e., issuing bank, card network, or other trusted facilitator which will then, upon approval, release the primary key downstream to the POS system where it can then link the receipt data to the primary key and forward it to the database/cloud server. This method alone can remove the potential issue of consuming computing power with repeated SHA calculations. For example, if future technology requires a more complex quantum cryptographic SHA to be used this may cause strain on existing payment processing infrastructure as each approval will then require more computing power per transaction possibly slowing the process.

Yet another embodiment contemplated herein, described as method three, is a combination of both methods one and two. This method takes advantage of method one's ability to generate a unique primary key on demand, while also storing that primary key similarly to method two. The combination of both these techniques allows for greater flexibility in many scenarios. For example, an instance where a party approving the payment does not want to participate in storing a primary key, one can simply be generated as and when needed for the POS system/intermediary. Another scenario would be if a participating bank or card network has a high volume of transactions and would like to ease the workload on its server systems. In this instance the primary key can be generated once and then stored with the account information for reference at the time of subsequent approved transactions.

In summary, method one takes advantage of generating a primary key on demand for the POS system/intermediary. Method two takes advantage of the payment processing infrastructure already in place to pass a primary key to the POS system/intermediary. Used together, method one and method two create method three, the most versatile system for linking the POS generated transaction information to the specific individual and/or payment instrument, whether used in online, in-person, or remote transactions.

These methods are unique in the way they operate because they allow for the receipts to be stored by payment method. Additionally, all methods eliminate any input or changes to the purchaser side of the POS process.

Having any one of the above methods implemented, together with a suitable online server/database, will allow users simple access, storage, retrieval, sorting, querying, transferring, and downloading of all receipt data linked to the payment method. The receipt data can be laid out on a GUI (graphical user interface) on a web page or app, accessible through an internet connection. Purchaser users can also have the functionality to select items on a receipt and create an invoice or other documentation. For example, an invoice for an individual or company that participated in a transaction, for which partial reimbursement is expected. The payment can be made through the GUI in the event that the participating individual or company is also participating in the Electronic Receipt Service, or by a secure weblink in the event that they are not. Other GUI functionality would allow for the data to be analyzed automatically or by the user for insights, trends and other information that may be deemed useful by the user.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates schematic of a credit and debit card payment processing system working in conjunction with a merchant POS system where both parties are physically present together to accept payment and generate transaction information, according to some embodiments;

FIG. 2 illustrates a schematic of a payment processing system working in conjunction with an online merchant website where there is no physical representation of a merchant or its payment processing hardware to accept payment and generate transaction information, according to some embodiments;

FIG. 3 illustrates a schematic of the implementation of the technological embodiments described within this disclosure as applied to the process described in FIG. 1, according to some embodiments;

FIG. 4 illustrates a schematic of the implementation of the technological embodiments described within this disclosure as applied to the process described in FIG. 2, according to some embodiments;

FIG. 5 illustrates a flowchart of how a Secure Hash Algorithm (SHA) method is used to generate a primary key, according to some embodiments;

FIG. 6 illustrates a schematic of the basic functions within the intermediary sub-program that prepares data for the E-receipt sever/database, according to some embodiments;

FIG. 7 illustrates a schematic showing how the server functions and how information is accessed within the system, according to some embodiments;

FIG. 8 illustrates a schematic demonstrating what a purchaser user can expect to see when accessing their data within the graphical user interface (GUI), according to some embodiments; and

FIG. 9 illustrates a block diagram of an exemplary computer system infrastructure, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “transaction” is used to describe any interaction between a merchant and purchaser that results in an exchange of goods, services, and/or payments.

As used herein, the terms “transaction information”, “transaction data”, “receipt”, “receipt information”, and “receipt data” may be used interchangeably and are defined as: any form of information relevant to a specific commerce transaction including but not limited to the following:

Merchant information: This includes the name, address, and contact details of the business, merchant or entity that is receiving payment. It may also include the merchant's logo or branding information.

Transaction details: Details about the specific transaction, such as the date and time of the purchase. It may include a unique transaction or receipt number for reference purposes.

Itemized list: Itemized list of the products, goods, or services purchased during the transaction. Each item is listed along with its corresponding quantity, description, UPC, SKU, and price.

Pricing Information: Price of each item, as well as any applicable taxes, discounts, or additional fees. It may also indicate the total cost of the transaction, including the subtotal and the final amount paid.

Payment Method: Indicates the payment method used for the transaction, such as credit card, cash, check, or mobile payment.

Merchant Identification: Depending on local regulations, the data may include the merchant's tax identification number or other identifying information required for taxation or legal purposes.

Return and Refund Policy: Information about the merchant's return and refund policy, specifying the conditions and timeframes for returning or exchanging purchased items.

Additional Information: The receipt may include any additional details related to the transaction, such as warranty information, customer service contact information, instruction manuals, web links, shipping numbers, loyalty points, etc.

As used herein, the term “primary key” is used to identify a purchases user, payment account, payment method, entity, and/or payment instrument.

As used herein, the term “Electronic Receipt Service” or “E-Receipt Service” is used to describe the service of a company utilizing the systems and methods described herein.

As used herein, the term “merchant” is used to describe any business, retailed, company, seller, vendor, supplier, or individual engaged in the provision and/or sale of goods and/or services.

As used herein, the term “purchaser” is used to describe a buyer, or the recipient of a product, service, or good from a merchant under agreement, typically for monetary or other valuable consideration.

As used herein, the term “user” is used to describe a merchant user, a purchaser user, or other user of the system.

As used herein, the term “payment account” is used to describe a bank account in which the payment method(s) refer(s) to.

As used herein, the term “payment method” or “method of payment” is used to describe a specific payment instrument.

As used herein, the term “payment instrument” is used to describe any method or tool used to facilitate the transfer of funds or make payments for goods, services, or obligations. The payment instrument servers as a medium through which individuals or entities exchange value to settle financial transactions (i.e., debit cards, credit cards, crypto currencies, electronic wallets, checks, wire transfers, QR codes, etc.

As used herein, the term “commerce” is used to describe any form of commerce including e-commerce.

As used herein, the term “payment processing” is used to describe the handling and facilitation of financial transactions between a customer and a business, typically involving the exchange of money for goods or services. It involves a series of steps that securely capture, transmit, and authorize payment information, ultimately enabling the transfer of funds from the purchaser's account to the merchant's account. Payment processing can involve multiple parties, including payment processors, gateways, terminals, merchant account providers, acquiring banks, issuing banks, and payment networks (such as Visa™, Mastercard™, American Express™, etc.). These entities work together to ensure a secure flow of funds during the payment transaction.

As used herein, the term “POS” refers to a point-of-sale system which may include any cash register, inventory, tracking, or receipt generating apparatus.

As used herein, the terms “software”, “program”, and “sub-program” refers to a collection of coded instructions, data structures, and related materials that are designed to enable electronic devices, computers, or systems to perform specific tasks, functions, or operations. It encompasses both the code itself, often written in programming languages, and any associated documentation, user interfaces, and data files.

As used herein, the term “intermediary” refers to any device that carries out the process of sending the transaction data and primary key to the e-receipt server for storage. e.g., a merchant POS system, merchant website, terminal, etc.

In general, the embodiments provided herein relate to a system and method to seamlessly capture, track, store, and sort through receipt information details when merchant/purchaser transactions are made through any electronic payment. The system described herein solves a number of problems related to the capture and sharing of receipt information which are not easily solved under existing or other techniques. The system also provides storage and analytical capabilities to provide access and utilization of the captured data by the merchant user, purchaser user, and other permitted third-party users. The data capture and sharing technology described herein utilizes existing and future payment processing network infrastructure. In certain cases, the system does not require the use of payment processing network infrastructure. Further, the system may not require the purchaser user to actively participate in the data capturing beyond initially signing up for the service. The system makes all data accessible for utilization in a sortable, query-able and exportable format. The system also provides certain merchant benefits at the POS that would not otherwise be available.

Some embodiments include systems and methods related to the purchase of goods and/or services and the electronic storage of receipt information. Specifically, a system and method of electronically gathering and storing receipt information from a commerce transaction to a primary key interrelated to a purchaser user, payment account, payment method, and/or payment instrument. Through methods of creating a primary key, then receiving a primary key from a payment processing system and sending over a network, the primary key and transaction information to a server for storage and other functions. Which enables post sale accessing of the receipt by the purchaser user, merchant user, or other services enabled by the parties relevant to the transaction.

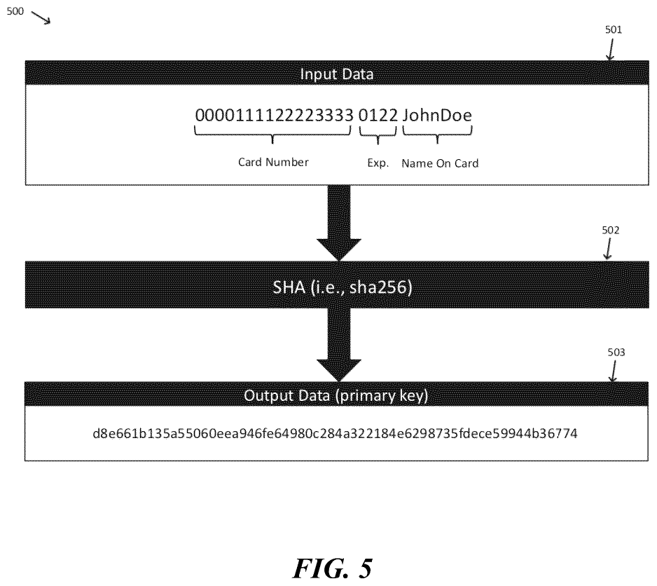

From herein, unless explicitly stated, systems and methods that have options for achieving the same fundamental tasks such as formats, SHA's 502, primary key's 503, etc. (see FIG. 5) can vary based on situation, circumstance, or necessity.

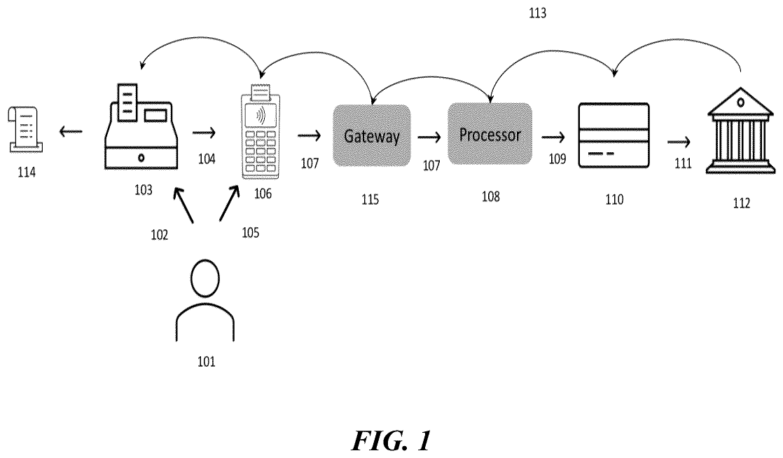

Referring to FIG. 1, a conventional commerce transaction starts with the purchaser 101 which has decided to purchase goods or services 102. The goods or services 102 are listed and the total price of these items along with any discounts, taxes, or fees are calculated in the merchants POS system 103. From there the total transaction amount 104 is sent to the terminal 106. The terminal 106 takes the transaction amount 104 and the customers payment method 105 and then sends this combined information 107 to the gateway 115 then the processor 112. The processor 112 then takes the information 107 and sends a request for approval 109 to the appropriate card network 110. The card network 110 will then pass the request 111 to the issuing bank 112 for approval. Approval or denial will be passed back down the line in reverse order 113. Often times the gateway 115 can be integrated into the terminal 106 or processor 112. An individual gateway 115 can be used to route payments to different processors 112. When the selling party's POS 103 receives an approval 113 from the terminal 106. The transaction is then completed and a physical receipt 114 is generated.

In some embodiments, the gateway 115 and processor 112 may be enacted as a single step.

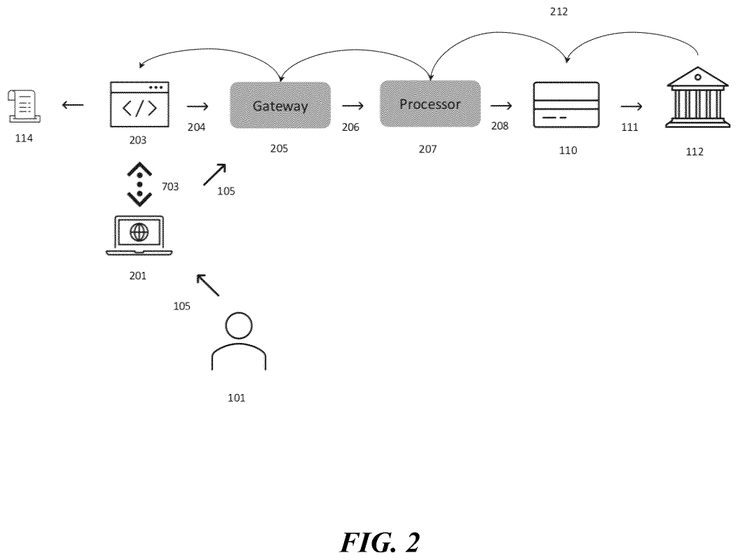

Referring to FIG. 2, an e-commerce transaction starts with the purchaser 101 who has decided to purchase goods or services from a merchant's website 203. The merchant's website server 203 is accessed on the purchaser's 101 computing device 201 through a network connection 703. When the purchaser 101 is ready to check out, the goods or services are listed and the total price of these items along with any discounts, taxes, or fees are calculated on the merchant's website 203. From there, total sales price 204 is sent to the payment gateway 205. Then the purchaser is redirected to the payment gateway 205 page where the payment method 105 is requested. The purchaser 101 then inputs the payment method information 105 and confirms the purchase. The gateway 205 takes the transaction details 204 and payment method 105, encrypts them 206 and sends it to the processor 207. The processor 207 then takes the information 206 and sends a request for approval 208 to the appropriate card network 110. The card network 110 will then pass the request 111 to the processor 112 for approval. Approval or denial will be passed back down the line in reverse order 212. When the merchant's website 203 receives an approval 212 the transaction is completed and a confirmation and receipt 114 is generated.

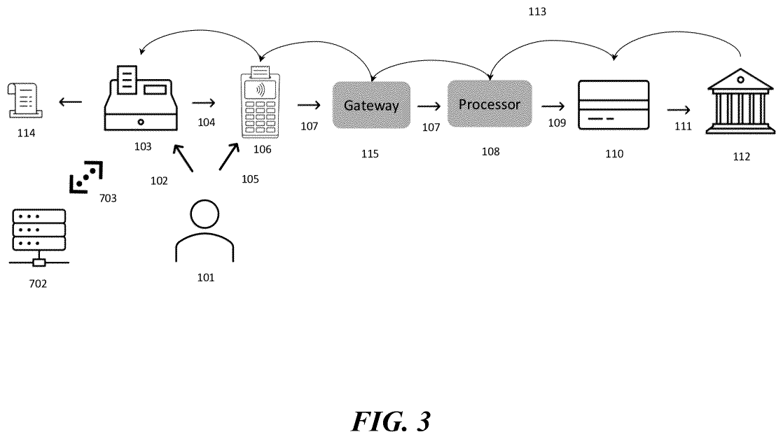

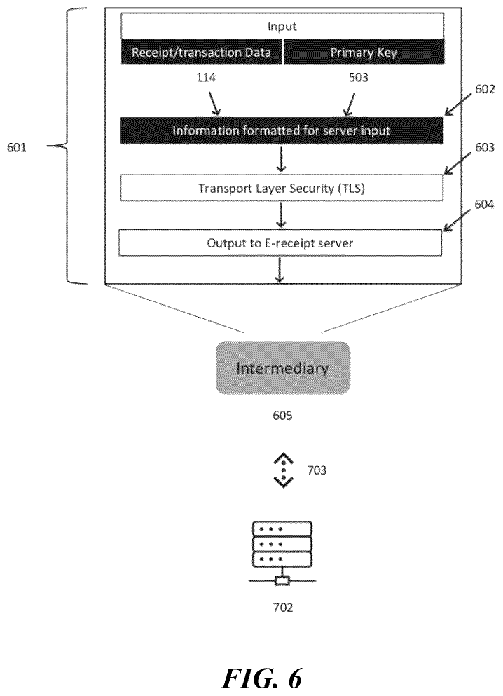

Referring to FIG. 3, FIG. 5 and FIG. 6, all the steps described in FIG. 1 would proceed as explained above, with the addition of the steps in methods one, two, or three described in the summary of invention. Each method will be described in its own paragraph. Adding the steps of method one a primary key 503 will be created using a SHA. The details of this process will be referred to as method one 500 further described in FIG. 5. Method one 500 can take place on any system that has access to the input data 501. This will typically take place at some point in the payment processing system i.e., terminal 106, gateway 115, processor 108, card network 110, or issuing bank 112. When method one 500 has been executed, a primary key 503 will be formed. The primary key 503 will be passed alongside the typical information in the payment processing system to the merchant's POS system 103. The merchant's POS system 103 has an intermediary sub-program 601 integrated within it, further explained in FIG. 6. Upon payment approval 313 the POS system 103 will execute the intermediary sub-program 601, thereby sending the primary key 503 and transaction information 114 over a network 703 to a server 702.

Referring again to FIG. 3, FIG. 5 and FIG. 6, and applying method two from the summary of invention, a primary key 503 is created upon enrollment into the service described within this disclosure. The primary key 503 is then stored within one or more of the participants in the payment processing system i.e., terminal 106, gateway 115, processor 108, card network 110, issuing bank 112, and/or the payment method 105 i.e., debit cards, credit cards, crypto currency's, electronic wallets, QR codes, etc. When the merchants POS system 103 has made a request for payment 104, there are a few different ways the primary key 503 can be delivered to the merchants POS system 103. In one option, the terminal 106 would read the primary key 503 off the payment method 105 chosen by the purchaser user 301 then pass it to the merchant's POS system 103. A second option would include having any of the other participants in the payment processing system realize the payment request and pass the primary key 503 alongside the typical information in the payment processing system to, the merchant's POS system 103. Again, the merchant's POS system 103 will have a intermediary sub-program 601 further explained in FIG. 6. It is from this point the intermediary sub-program 601 will proceed with sending the primary key 503 and transaction information 114 over a network 990 to a computer system 900.

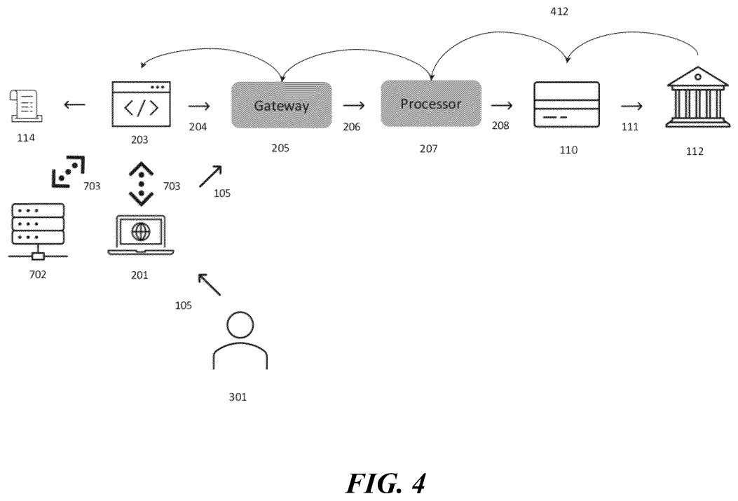

Referring to FIG. 4, FIG. 5, and FIG. 6., all the steps described in FIG. 2 would proceed as explained above, with the addition of the steps in methods one, two, or three described in the summary of invention. Again, each method will be described in its own paragraph. Adding the steps of method one 500, a primary key 503 will be created using a SHA 502. The details of this process will be referred to as method one 500 further described in FIG. 5. Method one 500 can take place on any computing device that has access to the necessary input data 501. This can take place on the host computing device 201 the merchant website 203 was accessed, if not it can take place on the merchant's website server 203 or at some point in the payment processing system i.e., gateway 205, processor 207, card network 110, or issuing bank 112. If method one 500 takes place on the host computing device 201, it can pass the primary key 503 directly to the merchant's website 203. In the case the primary key 503 is generated at some point in the payment processing system it will be passed alongside the typical information in the payment processing system to the merchant's website 203. The merchant's website 203 has a intermediary sub-program 601 integrated within it, further explained in FIG. 6. Upon payment approval, the merchant's website 203 will cause the intermediary sub-program 601 to execute, thereby sending the primary key 503 and transaction information 114 over a network 703 to a server 702.

Referring again to FIG. 4, FIG. 5, and FIG. 6., and applying method two from the summary of invention, a primary key 503 is created upon enrollment into the service described within this disclosure. The primary key 503 is then stored within one or more of the participants in the payment processing system i.e., gateway 205, processor 207, card network 110, issuing bank 112 and/or the computing device 201 used to access the merchant's website 203. When the merchant's website 203 has made a request for payment 204, there are a few different ways the primary key 503 can be delivered to the merchant's website 203. Options would include having at least one of the other participants in the payment processing system realize the payment request and pass the according primary key 503 alongside the typical information in the payment processing system to the merchant's website 203. Again, the merchant's website 203 will have a intermediary sub-program 601 further explained in FIG. 6. It is from this point the intermediary sub-program 601 will proceed with sending the primary key 503 and transaction information 114 over a network 703 to a server 702.

Referring to FIG. 3, FIG. 4, FIG. 5, and FIG. 6 and applying method three from the summary of invention. It is in this method that the systems and processes described in methods one and two can be combined. The combination of these methods, systems and processes can be implemented as needed. For example, in FIG. 3, it might be most convenient to store the primary key 503 on the customers payment instrument this way the terminal 106 can just pass it to the intermediary 605. But this process is not possible if a purchase is made online i.e., FIG. 4, so taking advantage of method one's 500 ability to create a primary key 503 on the computing device 201 displaying the merchant's website 203 would be an option. Or instead of adding the primary key 503 to the payment instrument the processor 112 would prefer to send it over 313 as the request for payment 104 is approved.

Referring to FIG. 5, this is a high-level example and demonstration of operation of the Primary key software (machine read able code) representing method one 500. In this example, credit card or debit card data is used, and the SHA 502 used is sha256. As explained above method one 500 can operate on any of the devices involved in the commerce transactions FIG. 3 or FIG. 4. For this code to be executed it will need Input data 501. This data is part of, or all of the payment credentials used to make payment 105. This must then be arranged in a format decided upon at initialization and should be used from there on because the input format is essential to reproducing the primary key 503. Regardless of the format this data will be passed to step two, the SHA 502. The SHA 502 used (also decided upon at initialization) can be chosen based on the security level needed and will have an output used as a primary key 503.

Referring to FIG. 6, here is where the basic functions of the intermediary sub-program 601 are outlined. The intermediary sub-program 601 will be installed on a device known as the intermediary 605. The intermediary 605 is described as a device that has been giving the primary key 503 and has generated or received the transaction data 114 i.e., merchants POS system 103, merchant website 203, terminal 106, etc. The intermediary sub-program 601 will take the transaction data 114 and primary key 503 and format them 602 for the server 702. It can then carryout standard transport layer security (TLS) 603 procedures to prepare the information for output 604; sent over a network 703 to the sever 702.

In some embodiments, receipts are generated using the POS system and payments are processed using a payment terminal. The cashier scans items and the total price of the items is calculated, and the total payment amount is sent to the payment terminal. The customers payment card is inserted into the payment terminal. Steps described and illustrated in FIG. 5 are then executed and the payment terminal attempts to charge the payment card. The payment is approved, and the primary key is transmitted to the POS. Once the payment is approved, the POS generates a receipt for the transaction. The steps described and illustrated in FIG. 6 are then executed which involves sending the primary key and the receipt to the eReceipt server. In this example, the POS acts as the intermediary.

In some embodiments, it may be advantageous for the steps described in FIG. 5 to be executed on another third-party system that is in communication with the payment processing system. The third party system may be, for example, the issuing bank, payment network, etc. The primary key generated from this process can also be saved using one of the third-party systems and delivered to the POS (i.e., the intermediary in this example) upon approval of the payment.

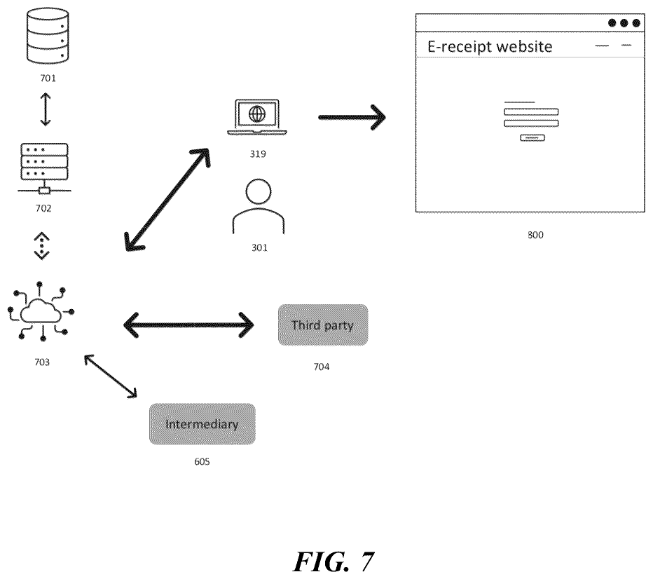

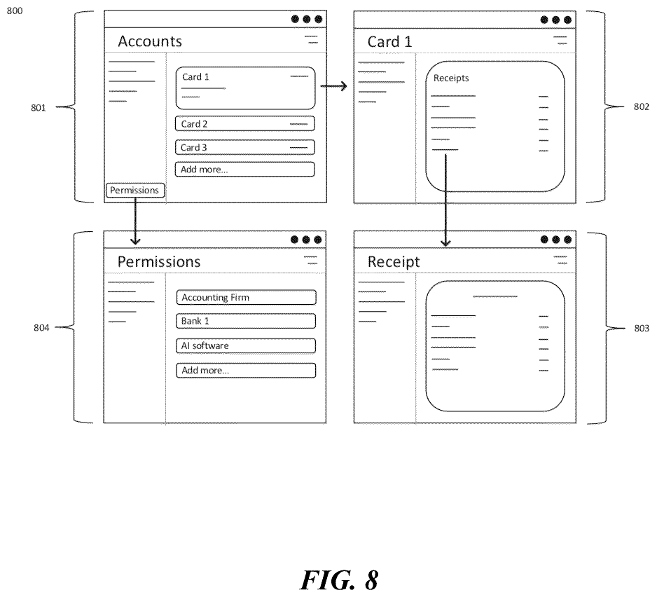

Referring to FIG. 7, the server 702 side of the system will receive its data from the intermediary 605 over a network or internet connection 703. From there the server will determine the primary key 503 and store the received transaction data 114 accordingly in a database(s) 701. This stored data can be accessed by a purchaser user 301, merchant user, or third party 704 through an internet connection 703 to the server 702. A purchaser user 301 can use a personal computing device 319 to access an E-receipt website 800 for easy viewing and access of the stored data (examples continue on FIG. 8). A merchant user will also have a web interface better suited for data analytics, market trends and queries. Consumer users can also grant permissions to retrieve and display data on third party applications 704 i.e., online banking, accounting software, artificial inelegance, etc.

Referring to FIG. 8, upon logging into a purchaser user 301 account on the e-receipt website 800, a purchaser user 301 can expect to see all their payment accounts or payment methods 105 enrolled into the service under the accounts page 801. Next when an account is selected you will be brought to the transactions page 802, this is where a list of individual transactions that took place on that account will appear. If a transaction is selected, you will be brought to the receipt page 803. This is where a purchaser user 301 can see all the transaction data such as items purchased, quantity and price as well as shipping numbers, tutorials, instructions, etc. Another one of many functionalities is shown as the permissions page 804, where the purchaser user 301 can grant access to third party applications 704. Other functionalities include downloading data, running queries for induvial products, and creating invoices from selected items on other transactions and requesting payment from other purchaser users 301.

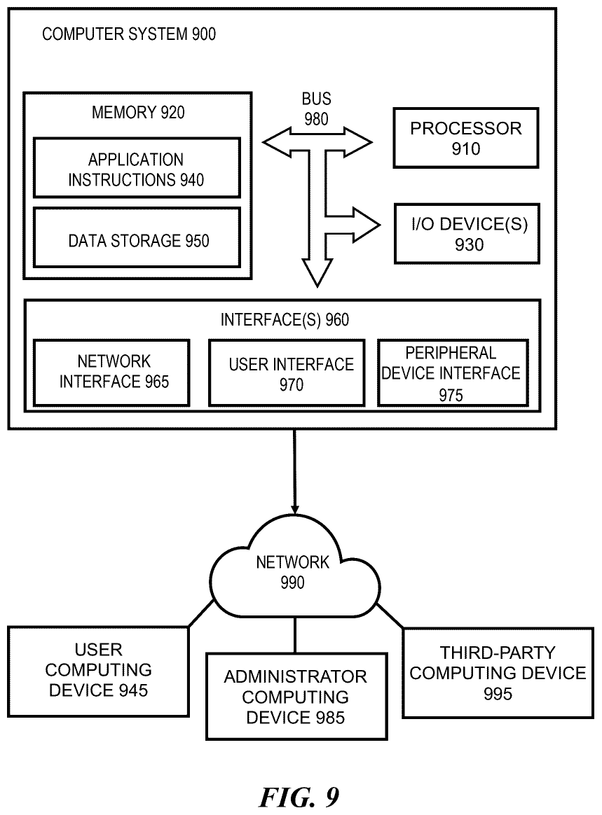

FIG. 9 illustrates an example of a computer system 900 that may be utilized to execute various procedures, including the processes described herein. The computer system 900 comprises a standalone computer or mobile computing device, a mainframe computer system, a workstation, a network computer, a desktop computer, a laptop, or the like. The computing device 900 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 900 includes one or more processors 110 coupled to a memory 920 through a system bus 980 that couples various system components, such as an input/output (I/O) devices 930, to the processors 910. The bus 980 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 900 includes one or more input/output (I/O) devices 930, such as video device(s) (e.g., a camera), audio device(s), and display(s) are in operable communication with the computer system 900. In some embodiments, similar I/O devices 930 may be separate from the computer system 900 and may interact with one or more nodes of the computer system 900 through a wired or wireless connection, such as over a network interface.

Processors 910 suitable for the execution of computer readable program instructions include both general and special purpose microprocessors and any one or more processors of any digital computing device. For example, each processor 910 may be a single processing unit or a number of processing units and may include single or multiple computing units or multiple processing cores. The processor(s) 910 can be implemented as one or more microprocessors, microcomputers, microcontrollers, digital signal processors, central processing units, state machines, logic circuitries, and/or any devices that manipulate signals based on operational instructions. For example, the processor(s) 910 may be one or more hardware processors and/or logic circuits of any suitable type specifically programmed or configured to execute the algorithms and processes described herein. The processor(s) 910 can be configured to fetch and execute computer readable program instructions stored in the computer-readable media, which can program the processor(s) 910 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 920 includes computer-readable application instructions 950, configured to implement certain embodiments described herein, and a database 950, comprising various data accessible by the application instructions 940. In some embodiments, the application instructions 940 include software elements corresponding to one or more of the various embodiments described herein. For example, application instructions 940 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 910 such that the processor 910 can read information from, and write information to, the storage medium. In the alternative, the storage medium may be integrated into the processor 910. Further, in some embodiments, the processor 910 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 940 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 940 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 940 can be downloaded to a computing/processing device from a computer readable storage medium, or to an external computer or external storage device via a network 990. A network adapter card or network interface in each computing/processing device receives computer readable program instructions from the network and forwards the computer readable application instructions 940 for storage in a computer readable storage medium within the respective computing/processing device.

In some embodiments, the computer system 900 includes one or more interfaces 960 that allow the computer system 900 to interact with other systems, devices, or computing environments. In some embodiments, the computer system 900 comprises a network interface 965 to communicate with a network 990. In some embodiments, the network interface 965 is configured to allow data to be exchanged between the computer system 900 and other devices attached to the network 990, such as other computer systems, or between nodes of the computer system 900. In various embodiments, the network interface 965 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 970 and the peripheral device interface 975.

In some embodiments, the network 990 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 990 can comprise copper transmission cables, optical transmission fibers, wireless transmission, routers, firewalls, switches, gateway computers and/or edge servers. The network 990 can represent a single network or multiple networks. In some embodiments, the network 990 used by the various devices of the computer system 900 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 900 may include a user computing device 945, an administrator computing device 985 and a third-party computing device 995 each in communication via the network 990. The user computing device 945 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 985 is utilized by an administrative user to moderate content and to perform other administrative functions. The third-party computing device 995 may be utilized by third parties to receive communications from the user computing device, transmit communications to the user via the network, and otherwise interact with the various functionalities of the system.

In this disclosure, the various embodiments are described with reference to the flowchart illustrations and/or block diagrams of methods, apparatus (systems), and computer program products.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for receiving, a primary key from a payment processing system where transaction information is sent to a server for the purposes of storing and analyzing transaction data, the system comprising:
at least one user computing device in operable connection with a user network;
an application server in operable communication with the user network, the application server configured to host an application program for accessing, storing, retrieving, sorting, querying, transferring, and downloading a plurality of receipt data linked to a primary key via;
a secure hashing algorithm receiving a plurality of payment information from payment processing system, the secure hashing algorithm to generate a primary key using the plurality of payment information,
wherein the application server is configured to transmit, via an intermediary, the plurality of receipt data and the primary key to an eReceipt server configured to receive and to store the primary key and the transaction information in a database.

2. The system of claim 1, wherein the plurality of receipt data includes an itemized list comprising at least one of the following: at least one product, at least one good, and at least one service.

3. The system of claim 2, wherein the plurality of receipt data includes the plurality of transaction information, the plurality of transaction information comprising at least one of the following: a date, a time, a receipt number, a merchant identification, a plurality of pricing information, a payment method, a purchaser identification, and a payment instrument.

4. The system of claim 1, wherein a point of sale system operates as the intermediary such that the point of sale system is capable sending the primary key and the plurality of transaction information to eReceipt server.

5. The system of claim 4, wherein the point of sale system is in operable communication with the payment processing system.

6. The system of claim 1, wherein a payment processing system operates as the intermediary such that the payment processing system is capable sending the primary key and the plurality of transaction information to eReceipt server.

7. The system of claim 1, wherein the merchants website operates as the intermediary such that the merchant's website is capable sending the primary key and the plurality of transaction information to eReceipt server.

8. The system of claim 1, wherein the secure hashing algorithm performs the following steps:
receiving, via a third-party device, the plurality of payment information to generate a primary key; and
transmitting the primary key to the intermediary.

9. The system of claim 1, wherein the intermediary performs the following steps:
receiving the plurality of transaction information and the primary key;
formatting the plurality of transaction information and the primary key; and
outputting the plurality of transaction information and the primary key to the eReceipt server.

10. The system of claim 1, wherein the primary key is stored by a third-party.

11. The system of claim 10, wherein the third-party delivers a primary key which was not generated by the secure hashing algorithm to the intermediary.

12. A method of receiving, by an intermediary, a primary key from a payment processing system where transaction information is sent to a server for the purposes of storing and analyzing transaction data, the method comprising the steps of:
receiving or generating via an intermediary, a plurality of transaction information;
generating, via the payment processing system a primary key based on a plurality of payment information; and
transmitting, via an intermediary in operable communication with a server, the primary key and the plurality of transaction data.

13. The method of claim 12, wherein a point of sale system operates as the intermediary such that the point of sale system is capable of receiving the primary key and the plurality of transaction information.

14. The method of claim 13, wherein the point of sale is in communication with a payment processing system to enable the acceptance of a payment, the generation of the primary key, and the secure transmission of the plurality of transaction information in a scenario where the point of sale system and the payment processing system are physically present with each other.

15. The method of claim 14, wherein the payment processing system is in operable communication with a merchant website to enable the acceptance of a payment, the generation of the primary key, and the secure transmission of the plurality of transaction information in a scenario where the point of sale system and the payment processing system are not physically present with each other.

16. The method of claim 12, wherein the secure hashing algorithm performs the following steps:
receiving, via a third-party device, the plurality of payment information to generate a primary key; and
transmitting the primary key to the intermediary.

17. The method of claim 12, wherein the point of sale system performs the following steps:
receiving the plurality of transaction information and the primary key;
formatting the plurality of transaction information and the primary key; and
outputting the plurality of transaction information and the primary key to the eReceipt server where it is then saved in a database.

18. The method of claim 12, wherein the database is in operable communication with an e-receipt website to display, via a user interface, the plurality of transaction information.

19. A method for generating a primary key using payment credentials through the use of a secure hash algorithm for secure and repeatable primary key generation, the method comprising:
receiving a plurality of payment information;
generating a primary key based on the plurality of payment information;
releasing the primary key to an intermediary;
linking the primary key to a plurality of transaction data; and
transmitting, via an intermediary in operable communication with a server, the primary key and the plurality of transaction information to a database.
